(19) United States
(12) Patent Application Publication
(10) Pub. No.: US 2025/0004681 A1
(43) Pub. Date: Jan. 2, 2025

(54) COMMUNICATION SYSTEM AND IMAGE FORMING APPARATUS

(71) Applicant: CANON KABUSHIKI KAISHA, Tokyo (JP)

(72) Inventor: SORA KUMAGAI, Chiba (JP)

(21) Appl. No.: 18/752,269

(22) Filed: Jun. 24, 2024

(30) Foreign Application Priority Data
Jun. 28, 2023 (JP) 2023-105935

(51) Int. Cl. G06F 3/12

(52) U.S. Cl. CPC G06F 3/1248; G06F 3/121

(57) ABSTRACT

A communication system includes a server configured to render a web content, an image forming apparatus configured to form and print an image on a sheet, the image forming apparatus communicating with the server and displaying the rendered web content, and one or more controllers having one or more processors and one or more memories, the one or more controllers configured to display, on the image forming apparatus, a rendered image corresponding to a web content received from the server, transmit a first request relating to print data to the server through the rendered image displayed on the image forming apparatus, receive print data from an external apparatus based on the first request, and transmit, in a case where the server completes reception of the print data, a completion notification indicating completion of reception of the print data, to the image forming apparatus.

### BACKGROUND

### Field of the Disclosure

The present disclosure relates to a communication system and an image forming apparatus.

### Description of the Related Art

Japanese Patent Application Laid-Open No. 2020-174126 discusses a technique relating to an image forming apparatus. Japanese Patent Application Laid-Open No. 2003-173288 discusses a technique for storing data on a world wide web (WWW) in an image forming apparatus.

A communication terminal that is equipped with a web browser (hereinafter, referred to as browser) developed from the technique discussed in Japanese Patent Application Laid-Open No. 2003-173288 and has a function of browsing a web page on a browser has spread. A web page of an external service is displayed in the browser, which enables the communication terminal to cooperate with the external service.

As a form of the browser, a cloud browser generating a drawing result of a web page on a cloud server is used. According to the cloud browser, processing with high calculation load such as analysis processing and execution processing of the web page is performed on the server, which eliminates the calculation load applied to the communication terminal.

The cloud browser operates on a virtual machine operating on the cloud server. Various apparatus resources necessary for a personal computer (PC) are virtually allocated to the virtual machine. Accordingly, the browser operating on the virtual machine can operate in the same manner as in a case where the browser operates on the PC.

An inexpensive image forming apparatus and the like cannot have many apparatus resources. For this reason, such an image forming apparatus can operate a latest web page, furthermore, cooperate with the external service by using the above-described cloud browser.

In a case where browsing using the cloud browser is performed in the image forming apparatus, a file downloaded from the external service is stored not in the image forming apparatus but in a storage on the cloud browser.

When printing of a document file stored in the storage of the cloud browser is performed, the image forming apparatus cannot know a timing when the cloud server completes download and preparation of the print data.

### SUMMARY

According to embodiments of the present disclosure, a communication system includes a server configured to render a web content, an image forming apparatus configured to form and print an image on a sheet, the image forming apparatus communicating with the server and displaying the rendered web content, and one or more controllers having one or more processors and one or more memories, the one or more controllers configured to display, on the image forming apparatus, a rendered image corresponding to a web content received from the server, transmit a first request relating to print data to the server through the rendered image displayed on the image forming apparatus, receive print data from an external apparatus based on the first request, and transmit, in a case where the server completes reception of the print data, a completion notification indicating completion of reception of the print data, to the image forming apparatus.

Further features of the present disclosure will become apparent from the following description of exemplary embodiments with reference to the attached drawings.

### BRIEF DESCRIPTION OF THE DRAWINGS

FIG. 1 is a block diagram illustrating a system configuration example of a cloud browser.

FIGS. 2A and 2B are diagrams illustrating a hardware configuration example and a software configuration of a virtual machine.

FIGS. 3A and 3B are diagrams illustrating a hardware configuration example and a software configuration of an image forming apparatus.

FIG. 4 is a diagram illustrating a setting screen example of a cloud browser.

FIG. 5 is a diagram illustrating an example of a home screen of the image forming apparatus.

FIG. 6 is a diagram illustrating an example of a screen generated by a system of the cloud browser.

FIGS. 7A and 7B are diagrams each illustrating an example of an access screen.

FIGS. 8A and 8B are diagrams each illustrating an example of a sequence.

FIG. 9 is a diagram illustrating an example of the sequence.

FIGS. 10A and 10B are diagrams each illustrating an example of a screen when file download is selected.

FIG. 11 is a diagram illustrating an example of the sequence.

FIG. 12 is a flowchart.

FIG. 13 is a table illustrating classifications of file formats of a downloaded file.

FIGS. 14A and 14B are diagrams each illustrating an example of a screen.

### DESCRIPTION OF THE EMBODIMENTS

Some exemplary embodiments of the present disclosure are to be described in detail with reference to accompanying drawings. The exemplary embodiments described below do not limit the disclosure, and all of combinations of features described in the exemplary embodiments are not necessarily essential for solving means of the present disclosure. In the exemplary embodiments, an image forming apparatus is described as an example of an information processing apparatus. However, the information processing apparatus is not limited to the image forming apparatus.

A first exemplary embodiment is to be described.

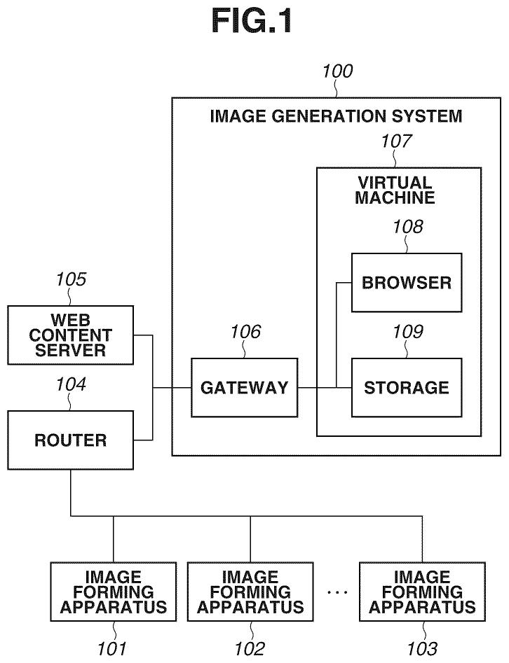

FIG. 1 is a diagram illustrating an example of a configuration of an entire communication system of a cloud web browser according to the present exemplary embodiment. In the system illustrated in FIG. 1, a user browses a screen of an image forming apparatus 101. The user operates the image forming apparatus 101 to input a uniform resource locator (URL) of a web content server 105 that the user desires to browse. The image forming apparatus 101 transmits the received URL of the web content server 105 to an image generation system 100 as an information processing system provided on a cloud, through a router 104. The image forming apparatus 101 has a function of printing an image, or a function of transmitting image data generated by scanning, to an optional address. FIG. 1 illustrates an example in which three image forming apparatuses are connected. However, the number of connected image forming apparatuses may be any number. The image forming apparatus 101, an image forming apparatus 102, and an image forming apparatus 103 each have the same configuration. In the following, the image forming apparatus 101 is to be described.

A browser 108 in a virtual machine 107 of the image generation system 100 receives the URL of the web content server 105 transmitted from the image forming apparatus 101, through a gateway 106. The browser 108 accesses the web content server 105 corresponding to the received URL through the gateway 106. The web content server 105 generates web contents of the required URL and transmits the web contents to the browser 108 as a request source. The browser 108 generates a drawing result of the web contents received from the web content server 105. As data to be used for the browser operation and the drawing generation, data stored in a storage 109 on the virtual machine 107 is used. The browser 108 transmits the generated drawing result of the web contents to the image forming apparatus 101 through the gateway 106. The image forming apparatus 101 receives the drawing result of the web contents transmitted from the image generation system 100, and presents the web contents to the user by, for example, displaying the received drawing result.

In the system of the cloud web browser, a plurality of image forming apparatuses like the image forming apparatuses 102 and 103 may be connected in addition to the image forming apparatus 101.

In the following description, the browser 108 operating on the virtual machine 107 and the image generation system 100 including the browser 108 are referred to as “cloud browser”. An entire system including operation of the image forming apparatus cooperating with the cloud browser is referred to as “system of cloud browser”.

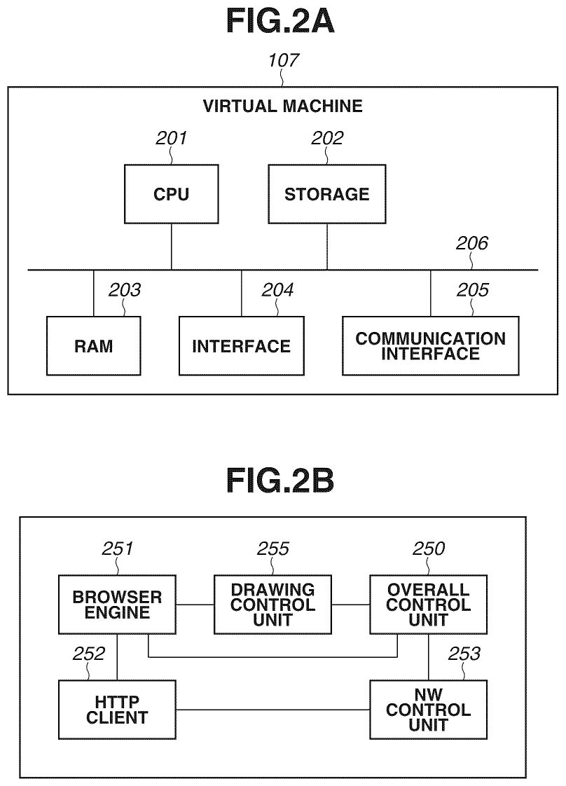

FIG. 2A is a block diagram illustrating a hardware configuration example of the virtual machine operating in the system of the cloud browser according to the present exemplary embodiment. A central processing unit (CPU) 201 performs various kinds of processing by using computer programs and data stored in a storage. As a result, the CPU 201 controls operation of the entire virtual machine 107, and performs or controls processing described as processing performed by the virtual machine 107. A storage 202 stores setting data on the virtual machine 107, computer programs and data relating to startup of the virtual machine 107, computer programs and data relating to basic operation of the virtual machine 107, and the like. A random access memory (RAM) 203 includes an area storing computer programs and data loaded from the storage 202, and data received from an external apparatus through a communication interface 205. The RAM 203 includes a work area to be used when the CPU 201 performs various kinds of processing. As described above, the RAM 203 can appropriately provide various kinds of areas (storage areas).

An interface 204 includes a display unit for displaying a processing result of the CPU 201 in the form of an image, characters, and the like, and an operation unit operated by the user to perform various kinds of operation input. The display unit includes a liquid crystal screen and a touch panel screen. The operation unit includes a user interface such as a keyboard, a mouse, and a touch panel screen. The communication interface 205 is an interface for performing data communication with an external apparatus. The CPU 201, the storage 202, the RAM 203, the interface 204, and the communication interface 205 are all connected to a bus 206.

The configuration illustrated in FIG. 2A is merely an example of the configuration applicable to the virtual machine according to the present exemplary embodiment, and it is not intended that the configuration is limited to the configuration illustrated in FIG. 2A. For example, in the configuration illustrated in FIG. 2A, a memory device may be further connected to the bus 206. The memory device includes, for example, a hard disk drive, a universal serial bus (USB) memory, a magnetic card, an optical card, an integrated circuit (IC) card, a memory card, and a drive device (drive device for storage medium such as flexible disk (FD), compact disk (CD), and other optical disks).

The virtual machine 107 can be formed by a so-called virtualization technique, and various resources included in a computer system can be organized in logical units independent of the physical configuration. In other words, the plurality of resources can be integrated to form the virtual machine 107, or one resource is divided and one of the divided resources can be formed as the virtual machine 107. In other words, the virtual machine 107 can be formed using at least a part of a plurality of resources (that may be configured by plurality of apparatuses) of the information processing system included in the cloud.

FIG. 2B is a diagram illustrating a software configuration of the virtual machine operating in the system of the cloud browser. An overall control unit 250 is a module controlling the whole of the virtual machine in the system of the cloud browser. A network (NW) control unit 253 is a module performing reception of communication from outside, transmission of data, and the like through the communication interface 205. The NW control unit 253 receives a rendering request of the web contents designated by the URL, and notifies the overall control unit 250 of the rendering request. Rendering indicates generation of an image and the like from abstract high-level information described in a data description language or a data structure. In the present exemplary embodiment, the image that has been rendered is referred to as a rendered image.

The overall control unit 250 receives the notification of the rendering request, and notifies a browser engine 251 of the designated URL. To acquire the web contents indicated by the URL, the browser engine 251 passes the URL to a HyperText Transfer Protocol (HTTP) client 252. The HTTP client 252 requests the NW control unit 253 to acquire the web contents of the designated URL through proxy. The NW control unit 253 accesses the URL through the designated proxy, and acquires the web contents. To draw information on the acquired web contents, the browser engine 251 requests a drawing control unit 255 to perform drawing. The overall control unit 250 notifies an external communication apparatus of image data drawn by the drawing control unit 255 through the NW control unit 253.

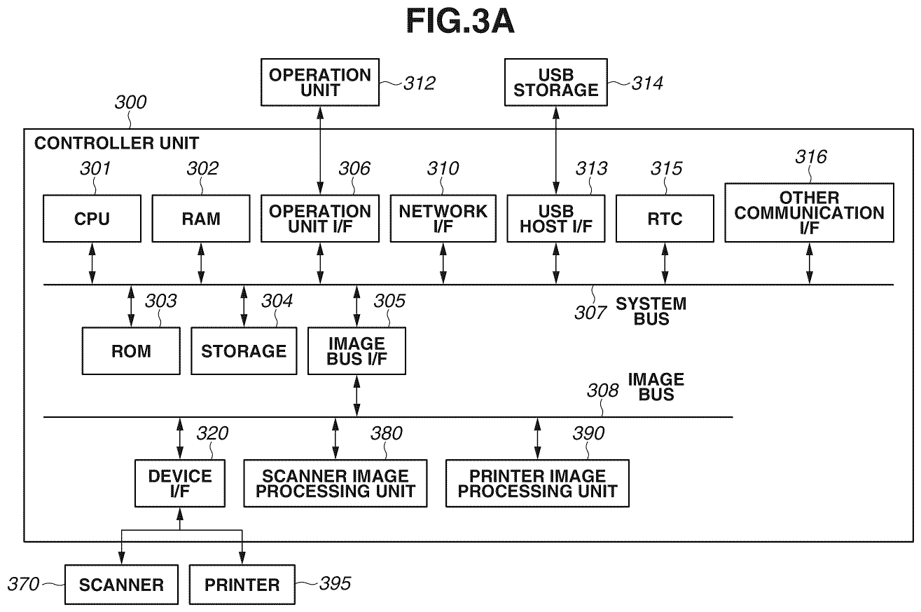

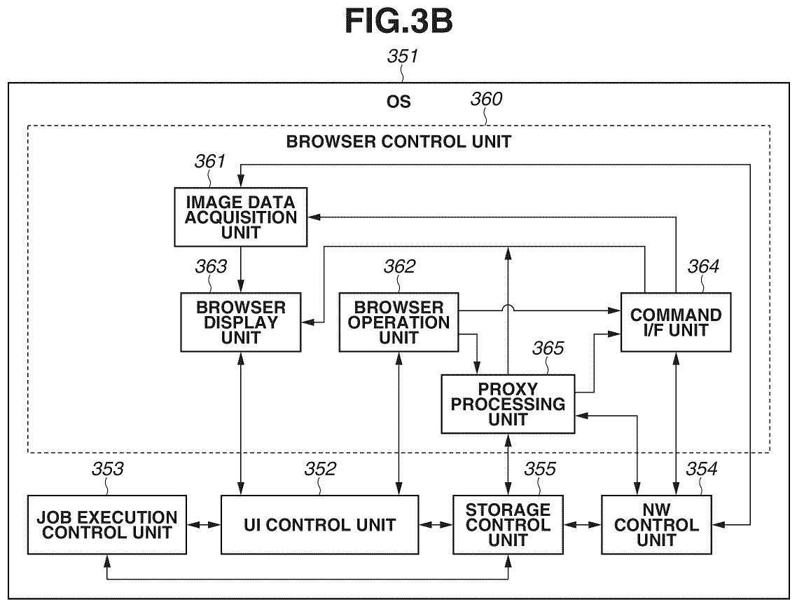

FIG. 3A is a diagram illustrating a hardware configuration of the image forming apparatus. The image forming apparatus includes a controller unit 300. A scanner 370 that is an image input device, a printer 395 that is an image output device, and an operation unit 312 are connected to the controller unit 300. The controller unit 300 performs control to realize a copy function of causing the scanner 370 to read a document and to generate image data, and causing the printer 395 to print and output the image data to a sheet.

The controller unit 300 includes a CPU 301. The CPU 301 starts up an operating system (OS) by a boot program stored in a ROM 303. The CPU 301 executes programs stored in a storage 304 on the OS, thereby performing various kinds of processing. The RAM 302 is used as a work area for the CPU 301. The RAM 302 provides the work area and an image memory area for temporarily storing image data. The storage 304 stores programs and image data.

The CPU 301 is connected to the ROM 303, the RAM 302, an operation unit interface (I/F) 306, a network I/F 310, a USB host I/F 313, and an image bus I/F 305 through a system bus 307. The operation unit I/F 306 is an interface for the operation unit 312 including a touch panel, and outputs image data to be displayed on the operation unit 312, to the operation unit 312. The operation unit I/F 306 transmits information input by the user on the operation unit 312, to the CPU 301. The network I/F 310 is an interface for connecting the image forming apparatus to a local area network (LAN).

The USB host I/F 313 is an interface communicating with a USB storage 314. The USB host I/F 313 also serves as an output unit causing the USB storage 314 to store data stored in the storage 304. The USB host I/F 313 receives data stored in the USB storage 314 and transmits the data to the CPU 301. The USB storage 314 is an external storage device storing data, and is detachable from the USB host I/F 313. A plurality of USB devices including the USB storage 314 is connectable to the USB host I/F 313.

A real time clock (RTC) 315 controls a current time. Time information controlled by the RTC 315 is used for recording a job input time and the like. The image bus I/F 305 is a bus bridge that connects the system bus 307 and an image bus 308 transferring image data at high speed, and converts a data format. The image bus 308 is a peripheral component interconnect (PCI) bus, a bus complying with Institute of Electrical and Electronics Engineers (IEEE) 3394, or the like. A device I/F 320, a scanner image processing unit 380, and a printer image processing unit 390 are connected to the image bus 308. The scanner 370 and the printer 395 are connected to the device I/F 320. The device I/F 320 performs synchronous/asynchronous conversion of image data. The scanner image processing unit 380 corrects, processes, and edits input image data. The printer image processing unit 390 performs correction, resolution conversion, and the like corresponding to the printer 395, on print output image data.

FIG. 3B is a diagram illustrating a software configuration of the image forming apparatus operating in the system of the cloud browser according to the present exemplary embodiment. Units illustrated by solid lines in FIG. 3B are software modules realized when the CPU 301 executes main programs loaded to the RAM 302. Execution of each of the modules described below corresponding to the main programs is managed and controlled by an operating system (OS) 351.

A user interface (UI) control unit 352 displays a screen on the operation unit 312, and receives operation from the user through the operation unit I/F 306. The UI control unit 352 notifies other modules of the user operation, and controls screen update in response to a drawing instruction from any of the other modules.

A job execution control unit 353 is a module controlling processing of a copy job, a scan job, a print job, and the like in response to a job execution instruction from the UI control unit 352.

A NW control unit 354 controls the network I/F 310 in response to a communication request from any of the other modules, and controls communication with an external apparatus. The NW control unit 354 receives a notification from the external apparatus, and notifies the other modules of contents of the notification.

A storage control unit 355 records and manages setting information and job information recorded in the storage 304. Each of the modules positioned on a layer of the OS accesses the storage control unit 355, and refers to and sets setting values.

A browser control unit 360 is a sub-module included in the OS 351, and performs control specific to the cloud browser according to the present exemplary embodiment to be described below. The number of sub-modules included in the OS may be any number.

Upon receiving the notification of the user operation from the UI control unit 352, a browser operation unit 362 notifies a command I/F unit 364 or a proxy processing unit 365 of contents of the user operation.

The proxy processing unit 365 receives the notification from the browser operation unit 362, and issues a request to acquire proxy setting information to the storage control unit 355. In a case where proxy setting is enabled based on the acquired proxy setting information, the proxy processing unit 365 issues a communication request to a proxy server through the NW control unit 354. The proxy processing unit 365 receives a response of the proxy server through the NW control unit 354, and notifies a browser display unit 363 or the command I/F unit 364 of a result obtained by processing contents of the response.

The command I/F unit 364 receives the notification from the browser operation unit 362 or the proxy processing unit 365, and requests communication with the image generation system 100 through the NW control unit 354. The communication request at this time includes notified information in some cases. The notified information may be user operation such as text input, link pressing, scroll, and zoom. For example, in a case of the text input, the notified information includes a character string input by the user. In a case of the link pressing, the notified information includes a pressed coordinate. In a case of scroll or zoom, the notified information includes a character string and the like corresponding to each of scroll and zoom. The command I/F unit 364 receives communication from the image generation system 100 through the NW control unit 354. The command I/F unit 364 processes the received contents, and notifies an image data acquisition unit 361 or the browser display unit 363 of the contents.

The image data acquisition unit 361 receives a URL on the storage 202 that is a storage destination of the rendering result, from the command I/F unit 364. The image data acquisition unit 361 receives an image from the URL, and passes the image to the browser display unit 363.

The browser display unit 363 receives the image from the image data acquisition unit 361, and instructs the UI control unit 352 to draw the image. The browser display unit 363 receives the notification from the command I/F unit 364 or the proxy processing unit 365, and issues a drawing instruction of a screen displaying a message corresponding to the notification.

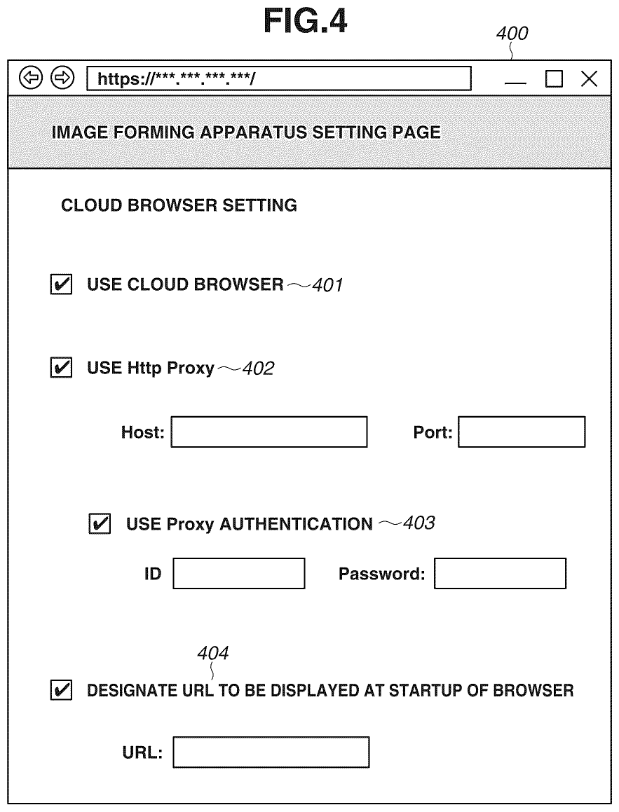

FIG. 4 is a diagram illustrating an example of a setting screen according to the present exemplary embodiment. The user accesses and browses a specific URL of the image forming apparatus, and operates the setting screen to perform setting of a cloud browser function. A cloud browser function switching checkbox 401 is a checkbox to be checked in a case where the cloud browser function is used.

A proxy use switching checkbox 402 is a checkbox to be checked in a case where proxy is used for web access. In a case where the proxy use switching checkbox 402 is checked, a host and port information on the proxy are set. A proxy authentication checkbox 403 is a checkbox to be checked in a case where proxy authentication is necessary. In a case where the proxy authentication checkbox 403 is checked, proxy authentication information (identification (ID) and password) is designated.

A startup URL designation checkbox 404 is a checkbox to be checked in a case where a URL first displayed at execution of the cloud browser function is designated. The set information is notified through the network I/F 310 and is recorded in the storage 304.

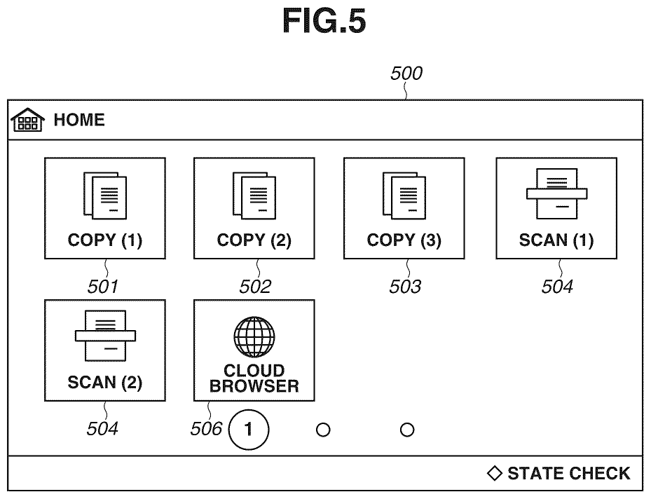

FIG. 5 is a diagram illustrating an example of a home screen displayed on the operation unit 312 of the image forming apparatus. A home screen 500 includes buttons 501 to 506 displaying functions relating to the image forming apparatus. In FIG. 5, buttons corresponding to six functions are displayed on the home screen 500. However, the number of buttons may be any number. The button 501 is an example of a button relating to a copy function. When the button 501 is pressed, the function associated with the button 501 is performed. The buttons 502 and 503 are also examples of the button relating to the copy function. As with the button 501, when the button 502 or 503 is pressed, the function associated with the pressed button is performed. The buttons 504 and 505 are examples of a button relating to a scan function. When the button 504 or 505 is pressed, the function associated with the pressed button is performed. The button 506 is an example of a button relating to the cloud browser function. When the button 506 is pressed, the function associated with the button 506 is performed.

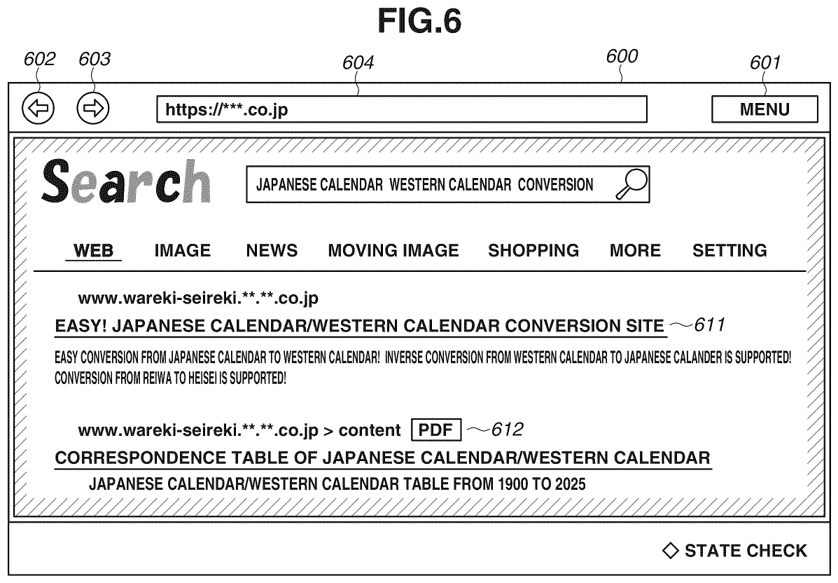

FIG. 6 is a diagram illustrating an example of a screen generated by the system of the cloud browser according to the present exemplary embodiment. A cloud browser screen 600 is displayed on the operation unit 312. In a case where the startup URL designation checkbox 404 is checked, the screen 600 at startup of the cloud browser displays the rendering result of the designated web page.

The setting of the startup URL acquired by the image forming apparatus 101 through the NW control unit 354 is stored in the storage 304. The proxy processing unit 365 acquires the startup URL with reference to the storage control unit 355 at startup of the cloud browser.

A rendering result 610 is an image sample rendered by the virtual machine 107. The rendering result 610 is displayed on the operation unit 312 when the image data acquisition unit 361 acquires the image data from the virtual machine 107, and the browser display unit 363 instructs the UI control unit 352 to perform drawing.

A menu button 601 is a button for referring to a bookmark and a history that are included in the browser function. When the menu button 601 is selected, for example, a cloud browser menu screen is displayed, and browsing of a bookmarked web page and a history of visited web pages is enabled.

A button 602 is an example of a button of a function of shifting a screen or returning user operation to a previous state, as one of the browser functions. When the button 602 is pressed, the operation unit 312 displays the rendering result in a state where operation is returned to previous operation. A button 603 is an example of a button of a function of shifting a screen or shifting the user operation to an advanced state, as one of the browser functions. The button 603 is selectable only in a case where the user operation can be advanced by one step. When the button 603 is pressed, the operation unit 312 displays the rendering result in a state where the user operation is advanced to next operation.

A character string display area 604 is an example of an area showing a URL and a title of the displayed web page. In a case where the user selects a link in the rendering result 610, for example, a link 611 for a web page or a link 612 for a Portable Document Format (PDF) file, the proxy processing unit 365 requests the virtual machine 107 to render a web page of the link destination.

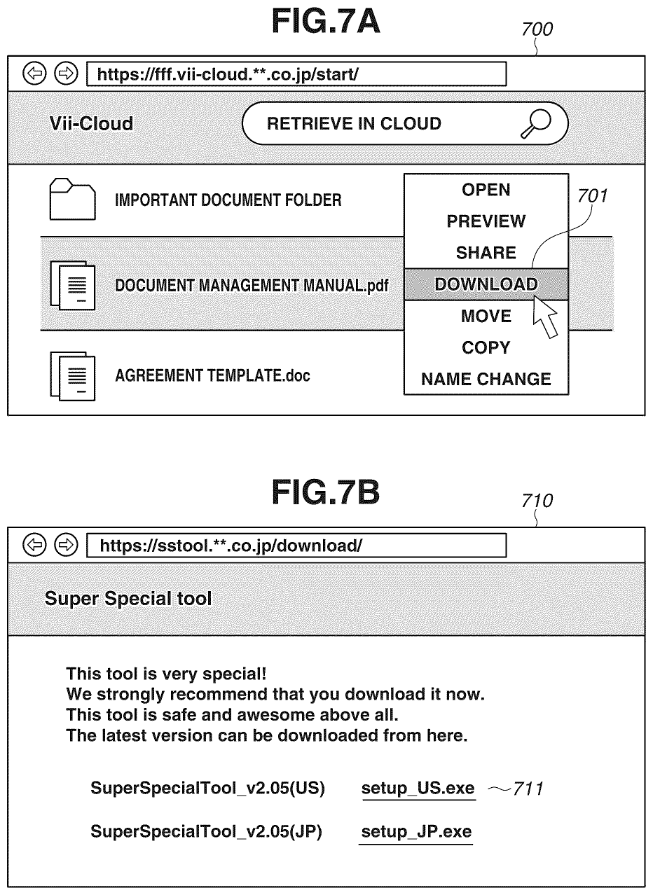

FIG. 7A is a diagram illustrating an example of a screen in a case of accessing the cloud storage service from a general browser. A browser screen 700 is a screen when a file is downloaded using the cloud storage service. In this example, when a download item 701 in a selection box in response to selection of a file is pressed, download from the web service is started using the browser function.

FIG. 7B is a diagram illustrating an example of a screen in a case of accessing a web site from a general browser. A browser screen 710 is a download screen of a web site distributing a program file. In this example, when a link 711 for a program file is pressed, download from the web service is started using the browser function.

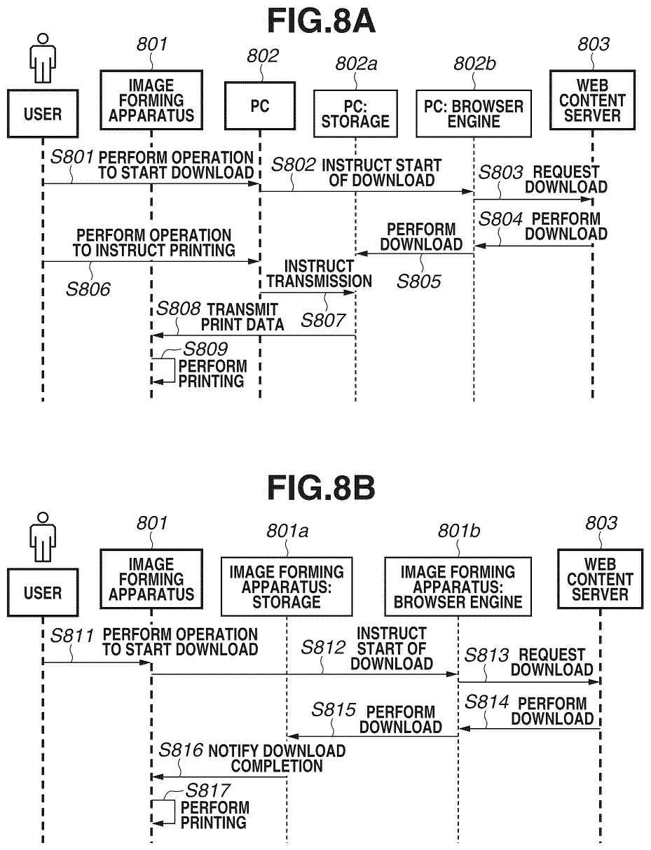

FIG. 8A is a sequence diagram illustrating a flow of printing contents downloaded from the web service by using a personal computer (PC) equipped with a general browser and an image forming apparatus, as a comparative example of the present exemplary embodiment.

In step S801, the user operates a PC 802, and performs operation to start download, for example, pressing of the download item 701 or pressing of the link 711 for the program file. In steps S802 and S803, the PC 802 instructs a browser engine 802b receiving the operation to start download, and requests download to a web content server 803.

In steps S804 and S805, when download from the web content server 803 is performed, the PC 802 stores the downloaded file in a storage 802a through the browser engine 802b.

In steps S806 and S807 after the file is stored, the user performs operation to instruct printing on the PC 802, and instructs the PC 802 to transmit the file in the storage. In steps S808 and S809, the PC 802 transmits print data to the image forming apparatus 801, and the image forming apparatus having received the print data performs printing.

FIG. 8B is a sequence diagram illustrating a flow of printing contents downloaded from the web service by using an image forming apparatus equipped with a browser function, as a comparative example of the present exemplary embodiment. The image forming apparatus 801 is controlled by the CPU 301.

In step S811, the image forming apparatus 801 receives operation to start download, for example, pressing of the download item 701 or pressing of the link 711 for the program file from the user. In steps S812 and S813, the image forming apparatus 801 having received the operation instructs a browser engine 801b to start download, and issues a download request to the web content server 803.

In steps S814 and S815, when the download from the web content server 803 is performed, the image forming apparatus 801 stores the downloaded file in a storage 801a through the browser engine 801b. In steps S816 and S817, the image forming apparatus 801 causes the printer 395 to perform printing with storing completion of the file in the storage 801a as a trigger.

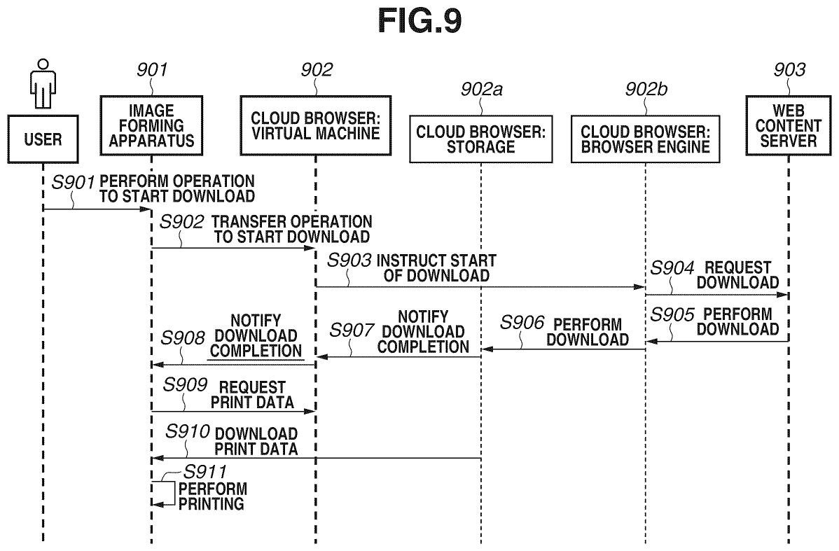

FIG. 9 is a sequence diagram illustrating a flow of printing contents downloaded from the web service, in the system of the cloud browser according to the present exemplary embodiment. An image forming apparatus 901 is controlled by the CPU 301.

In step S901, the image forming apparatus 901 receives operation to start download, from the user. In step S902, the image forming apparatus 901 having received the operation transfers the operation to start download, to a connected cloud browser 902. In steps S903 and S904, the cloud browser 902 having received the operation instructs a browser engine 902b to start download, and issues a download request to a web content server 903. In steps S905 and S906, when the download from the web content server 903 is performed, the cloud browser 902 stores the downloaded file in a storage 902a through the browser engine 902b. In steps S907 and S908, the cloud browser 902 notifies the connected image forming apparatus 901 of download completion, with storing completion of the file in the storage 902a as a trigger.

In step S909, the image forming apparatus 901 requests print data to the cloud browser 902 with the notification of the download completion in step S908 as a trigger. In response to the print data request in step S909, the cloud browser 902 transmits print data to the image forming apparatus 901. In steps S910 and S911, the image forming apparatus 901 causes the printer 395 to perform print processing for printing the received print data (image data) on a sheet.

After the print processing ends, and the connection between the image forming apparatus 901 and the cloud browser 902 is disconnected, the cloud browser storage 902a deletes the stored data.

In the present exemplary embodiment, the image forming apparatus 901 waits for reception of the notification of the download completion after transferring the operation to start download in step S902. Alternatively, the image forming apparatus 901 may perform polling to the cloud browser 902, and acquire the notification of the download completion as a response to the polling.

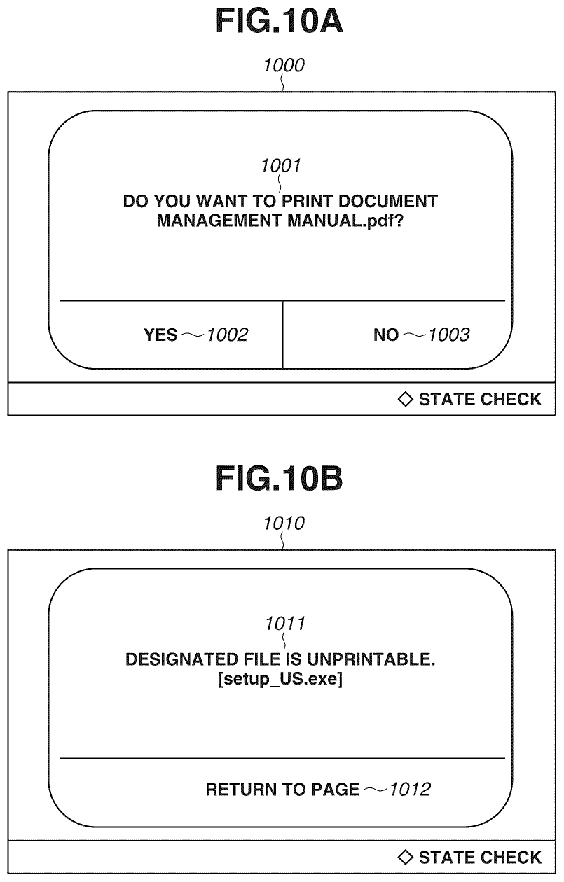

FIG. 10A is a diagram illustrating an example of a pop-up screen when file download is selected in the system of the cloud browser according to the present exemplary embodiment. FIG. 10A illustrates the pop-up screen in a case where the download item 701 is selected in the browser screen 700 of the cloud storage service in the system of the cloud browser. A print confirmation screen 1000 displays a file name 1001 of a download file to be printed. In a case where “YES” 1002 is selected, the image forming apparatus 901 starts the above-described printing sequence by regarding the selection operation as the operation to start download in step S901. In a case where “NO” 1003 is pressed, the image forming apparatus 901 returns the screen to the browser screen 700.

FIG. 10B is a diagram illustrating an example of a pop-up screen when download of a file in an unprintable file format is selected in the system of the cloud browser according to the present exemplary embodiment. In the present exemplary embodiment, a pop-up screen in a case where the link 711 for the program file is selected in the browser screen 710 of the web site distributing the program file, in the system of the cloud browser, is illustrated. The file to be downloaded is an execution file. Accordingly, a warning pop-up screen 1010 displays a message 1011 indicating that the file to be downloaded is unprintable. When “return to page” 1012 is pressed in the warning pop-up screen 1010, the screen returns to the browser screen 710.

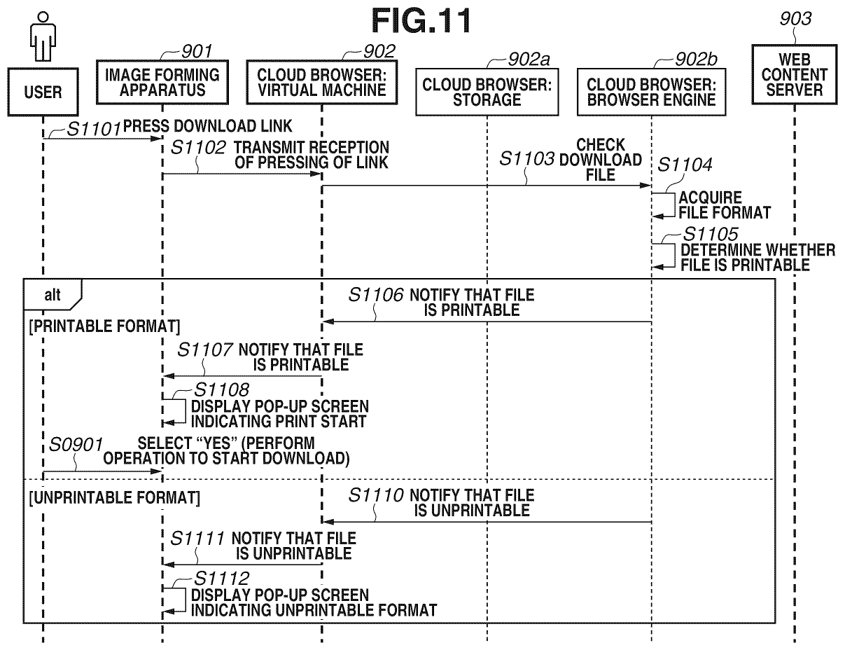

FIG. 11 is a sequence diagram illustrating a flow of operation when file download is selected in the system of the cloud browser according to the present exemplary embodiment. The image forming apparatus 901 is controlled by the CPU 301.

In steps S1101 and S1102, when receiving pressing of a download link, for example, pressing of the download item 701 or pressing of the link 711 for the program file from the user, the image forming apparatus 901 notifies the cloud browser 902 of reception of pressing of the link.

In step S1103, the cloud browser 902 checks the download file by the browser engine 902b. In steps S1104 and S1105, the browser engine 902b performs, as check of the file, acquisition of a file format from the link information, and determination whether the file is printable, based on the file format.

In a case where it is determined in step S1105 that the file is printable, the web content server 903 notifies the image forming apparatus 901 that the file is printable (printable file notification) through the cloud browser 902 in steps S1106 and S1107. The printable file is an image that can be handled as print data without performing conversion of the file format.

For example, the printable file includes a file in a PDF format.

In steps S1108 and S0901, the image forming apparatus 901 displays the print confirmation screen 1000 with the notification as a trigger. When “yes” 1002 is selected, the image forming apparatus 901 performs operation to start download. In a case where it is determined in step S1105 that the file is unprintable, the web content server 903 notifies the image forming apparatus 901 that the file is unprintable in steps S1110 and S1111. In step S1112, the image forming apparatus 901 displays the warning pop-up screen 1010 with the notification as a trigger. The unprintable file includes a file in a format requiring format conversion processing, for example, ZIP format.

After the print processing ends, and the connection between the image forming apparatus 901 and the cloud browser 902 is disconnected, the cloud browser storage 902a deletes the stored data.

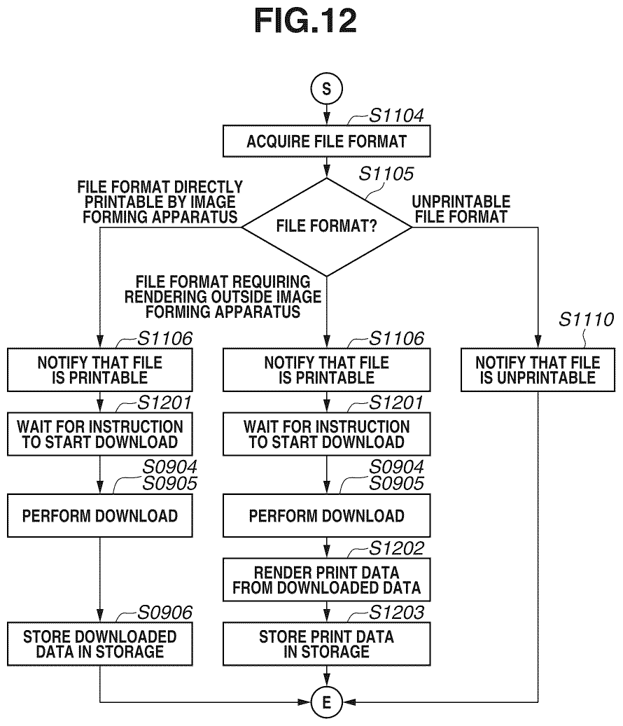

FIG. 12 is a flowchart illustrating processing for checking the download file in the system of the cloud browser according to the present exemplary embodiment. The flow corresponds to operation of the browser 108 in the above-described sequence.

In step S1104, the browser 108 acquires the file format of the file to be downloaded from multipurpose internet mail extensions (MIME) types. In step S1105, the operation is switched based on the file format acquired in step S1104. Classification of the file formats is described below.

In a case where the file is in a file format directly printable by the image forming apparatus (FILE FORMAT DIRECTLY PRINTABLE BY IMAGE FORMING APPARATUS in step S1105), the processing proceeds to step S1106. In step S1106, the browser 108 notifies the image forming apparatus that the file is printable. Thereafter, in step S1201, the processing waits for a download start instruction. In steps S0904 and S0905, download is performed in response to the start instruction. In step S906, the downloaded data is stored in the storage 109.

In a case where the file is in a file format requiring rendering outside the image forming apparatus (FILE FORMAT REQUIRING RENDERING OUTSIDE IMAGE FORMING APPARATUS in step S1105), the processing proceeds to step S1106. In step S1106, the browser 108 notifies the image forming apparatus that the file is printable. Thereafter, in step S1201, the processing waits for the download start instruction. In steps S0904 and S0905, download is performed in response to the start instruction. In step S1202, the downloaded data is rendered to print data. In step S1203, the print data is stored in the storage 109. In a case where the file is in an unprintable file format (UNPRINTABLE FILE FORMAT in step S1105), the processing proceeds to step S1110. In step S1110, the browser 108 notifies the image forming apparatus that the file is unprintable.

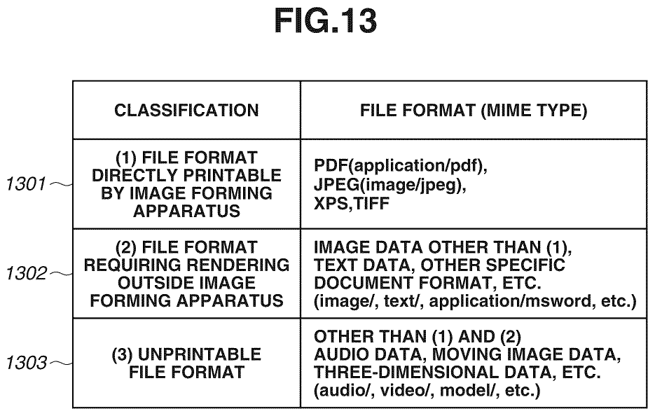

FIG. 13 is a table illustrating classifications of file formats of the downloaded file according to the present exemplary embodiment.

A first classification 1301 includes formats enabling data to be directly processed and printable by the image forming apparatus 101. A second classification 1302 includes formats enabling data to be converted into print data through rendering, such as an image, a text, and a document except for the first classification. A third classification 1303 includes all data formats not included in the first and second classifications.

The classifications depend on performance of the image forming apparatus and rendering performance of the browser engine. For this reason, the files are not precisely classified based on the file formats.

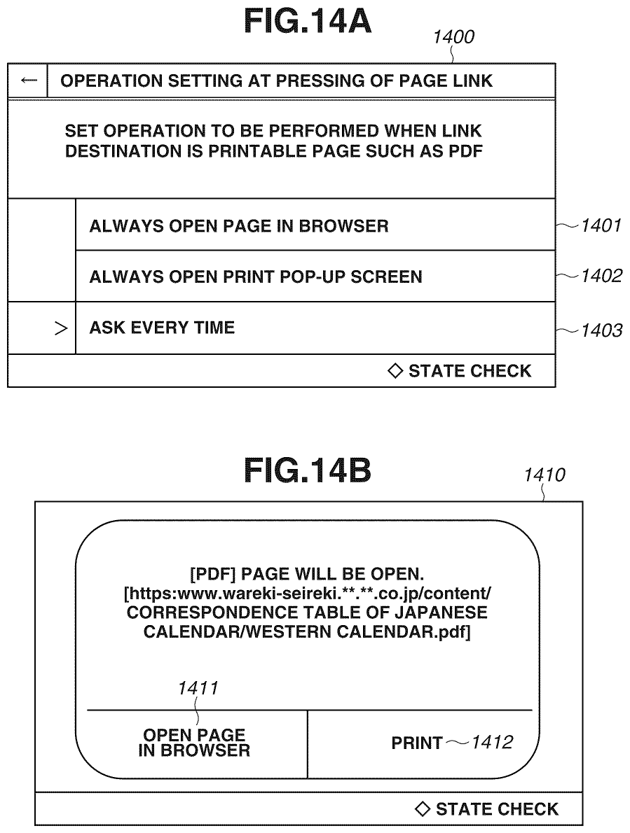

FIG. 14A is a diagram illustrating an example of an operation setting screen when a page link is pressed according to the present exemplary embodiment. For example, in a case of a PDF file, a link therefor is described in a page in some cases. Accordingly, there are a case where the user wants to print the PDF file and a case where the user wants to use the link for the PDF file.

The screen is to set operation when such a link in a page is pressed. Setting to “always open page on browser” 1401 is setting for always displaying a page on a browser screen when a link for a PDF file or the like is pressed. Setting to “always open print pop-up screen” 1402 is setting for always displaying the print confirmation screen 1000 when a link for a PDF file or the like is pressed. Setting to “ask every time” 1403 is setting for displaying a pop-up screen 1401 when a link for a PDF file or the like is pressed.

FIG. 14B is a diagram illustrating an example of an asking screen when the link is pressed according to the present exemplary embodiment. The pop-up screen 1410 is a screen displayed in a case where the operation setting when a link for a PDF file or the like is pressed is setting to “ask every time” 1403.

In the present exemplary embodiment, contents in a case where the link 612 for a PDF file is selected in the system of the cloud browser are described as an example. In a case where “open page in browser” 1411 is selected, the cloud browser 902 displays a page of the link destination. In a case where “print” 1412 is selected, the cloud browser 902 shifts a screen to the point confirmation screen 1000.

According to the configuration in the present exemplary embodiment, when printing of the document file stored in the storage on the cloud browser is performed, the image forming apparatus can know a timing when the cloud server completes download and preparation of the print data. Accordingly, the image forming apparatus can start data acquisition and printing execution.

Although various examples and the exemplary embodiment of the present disclosure are described above, the sprit and the scope of the present disclosure are not limited to the specific description in the present specification.

Embodiments of the present disclosure can be realized by supplying programs realizing one or more functions of the above-described exemplary embodiment to a system or an apparatus through a network or a storage medium, and causing one or more processors in a computer of the system or the apparatus to read out and execute the programs. Embodiments of the present disclosure can be realized by a circuit (e.g., application specific integrated circuits (ASIC)) realizing one or more functions.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-105935, filed Jun. 28, 2023, which is hereby incorporated by reference herein in its entirety.

What is claimed is:

1. A communication system comprising:
a server configured to render a web content;
an image forming apparatus configured to form an image on a sheet, the image forming apparatus communicating with the server and displaying the rendered web content; and
one or more controllers having one or more processors and one or more memories, the one or more controllers configured to:
display a rendered image corresponding to a web content received from the server;
transmit a first request relating to print data to the server through the rendered image displayed;
receive print data from an external apparatus based on the first request; and
transmit, in a case where the server completes reception of the print data, a completion notification indicating completion of reception of the print data, to the image forming apparatus.

2. The communication system according to claim 1, the one or more controllers configured to:
receive the completion notification; and
transmit, in a case where the completion notification is received, a second request relating to print data to the server.

3. The communication system according to claim 2, the one or more controllers configured to:
transmit the print data to the image forming apparatus based on the second request; and
cause the image forming apparatus to print an image on a sheet based on the print data transmitted from the server.

4. The communication system according to claim 2, wherein the second request is a request causing the server to transfer the print data to the image forming apparatus.

5. The communication system according to claim 1, the one or more controllers configured to transmit a third request to the external apparatus, the third request being transmitted from the server to the external apparatus based on the first request.

6. The communication system according to claim 1, wherein the completion notification is a response of polling transmitted from the image forming apparatus to the server.

7. The communication system according to claim 1, wherein the first request is a request causing the server to download the print data from the external apparatus.

8. The communication system according to claim 1, the one or more controllers configured to:
cause the server to check whether a file format of the print data is a file format printable by the image forming apparatus without converting the file format; and
cause, in a case where the print data is in the file format printable by the image forming apparatus, the server to accept the first request.

9. The communication system according to claim 8, wherein the printable file format is a Portable Document Format (PDF).

10. The communication system according to claim 8, the one or more controllers configured to cause, in a case where the print data is not in the file format printable by the image forming apparatus, the server to transmit a notification indicating an unprintable file format, to the image forming apparatus.

11. The communication system according to claim 10, wherein the unprintable file format is a ZIP format.

12. An image forming apparatus configured to form an image on a sheet, communicate with a server rendering a web content, and display the web content based on a result of the rendering, the image forming apparatus comprising:
one or more controllers having one or more processors and one or more memories, the one or more controllers configured to:
receive a rendered image corresponding to a web content from the server;
transmit a first request relating to print data to the server through the received rendered image; and
receive, in a case where the server completes reception of the print data from an external apparatus, a completion notification indicating completion of reception of the print data from the server.

13. The image forming apparatus according to claim 12, wherein the one or more controllers are configured to transmit a second request relating to the print data to the server in response to reception of the completion notification.

14. The image forming apparatus according to claim 13, wherein the one or more controllers are configured to:
receive the print data from the server after transmitting the second request to the server; and
cause the image forming apparatus to print an image on a sheet based on the print data after receiving the print data from the server.

15. The image forming apparatus according to claim 13, wherein the second request is a request causing the server to transfer the print data to the image forming apparatus.

16. The image forming apparatus according to claim 12, wherein the completion notification is a response of polling transmitted from the image forming apparatus to the server.

17. The image forming apparatus according to claim 12, wherein the first request is a request causing the server to download the print data from the external apparatus.

18. The image forming apparatus according to claim 12, wherein the one or more controllers are configured to receive, in a case where a file is in a printable file format, a notification indicating the printable file format from the server.

19. The image forming apparatus according to claim 18, wherein the printable file format is a PDF.

20. The image forming apparatus according to claim 18, wherein the one or more controllers are configured to receive, in a case where a file is in an unprintable file format, a notification indicating the unprintable file format from the server.

21. The image forming apparatus according to claim 20, wherein the unprintable file format is a ZIP format.
